(19) United States
(12) Patent Application Publication
(10) Pub. No.: US 2025/0030078 A1
(43) Pub. Date: Jan. 23, 2025

(54) RECYCLING METHOD OF WASTE LITHIUM MANGANATE CATHODE MATERIALS

(71) Applicant: KUNMING UNIVERSITY OF SCIENCE AND TECHNOLOGY, Kunming (CN)

(72) Inventors: Peng DONG, Kunming (CN); Yannan ZHANG, Kunming (CN); Bao ZHANG, Kunming (CN); Yingjie ZHANG, Kunming (CN)

(73) Assignee: KUNMING UNIVERSITY OF SCIENCE AND TECHNOLOGY, Kunming (CN)

(21) Appl. No.: 18/789,788

(22) Filed: Jul. 31, 2024

Related U.S. Application Data
(63) Continuation of application No. PCT/CN2023/128384, filed on Oct. 31, 2023.

(30) Foreign Application Priority Data
Jul. 18, 2023 (CN) 202310879618.9

(51) Int. Cl. H01M 10/54; C01G 45/12; C22B 7/00

(52) U.S. Cl. CPC H01M 10/54; C01G 45/1228; C22B 7/006; C01P 2002/72; C01P 2004/03; C01P 2006/40

(57) ABSTRACT

A recycling method of waste lithium manganate cathode materials is provided. The recycling method includes: firstly, mixing the waste lithium manganate cathode materials with sulfuric acid for hydrothermal reaction, to obtain manganese dioxide and washing solution; then reacting the washing solution with ammonium bicarbonate, to obtain manganese carbonate and lithium sulfate; and mixing the manganese dioxide, lithium sulfate and lithium hydroxide monohydrate, then performing a sintering treatment, washing and a tempering treatment in sequence, to obtain recycled lithium manganate cathode materials. The recycling method can obtain manganese dioxide, spherical manganese carbonate and lithium sulfate by adjusting the reaction temperature and reaction time, realizing the effective recovery of manganese and lithium. The lithium manganate cathode materials can be re-prepared by using the recovered manganese and lithium and adding lithium hydroxide monohydrate, and the lithium manganate cathode materials have excellent electrochemical performance.

### CROSS REFERENCE TO THE RELATED APPLICATIONS

This application is a continuation application of International Application No. PCT/CN2023/128384, filed on Oct. 31, 2023, which is based upon and claims priority to Chinese Patent Application No. 202310879618.9, filed on Jul. 18, 2023, the entire contents of which are incorporated herein by reference.

### TECHNICAL FIELD

The present disclosure relates to the technical field of recycling of waste lithium manganate cathode materials, in particular to a recycling method of waste lithium manganate cathode materials.

### BACKGROUND

With the increase of the service time of the lithium battery, the material structure will be gradually destroyed, and the electrochemical performance will be attenuated. In recent years, a large number of waste lithium-ion batteries have been produced. Lithium-ion batteries are usually composed of metal/metal oxides, organic chemicals, metal shells, etc. If the waste lithium-ion batteries are not properly treated, it will cause serious damage to human health and the environment. At the same time, the recycling of waste lithium-ion batteries has great economic benefits. Waste lithium-ion batteries can be regarded as a rich ore rich in lithium, nickel, cobalt, manganese and other metals. From the perspective of environmental protection and resource regeneration, waste lithium-ion batteries have great economic benefits and environmental protection value.

At present, the research on the recycling of waste lithium-ion batteries is mainly divided into the following three processes: a pyrometallurgical process, a hydrometallurgical process and a biometallurgical process. The pyrometallurgical process is mainly to burn the binder and carbon in the battery components through a high-temperature treatment, so as to separate the active substance. The pyrometallurgical process is simple and easy to operate, but it has the disadvantages of high energy consumption and waste gas generation. Biological metallurgy selectively extracts manganese, cobalt, lithium, nickel and other metal elements through the metabolic process of biological fungi. However, biological metallurgy is sensitive to metal concentration, temperature and other external factors, and the leaching rate is not high, which requires continuous research and improvement. Hydrometallurgy is considered to be an effective method for recycling spent lithium-ion batteries. The leaching process is the key part of the hydrometallurgical process. Through the synergistic effect of acid (HCl, H₂SO4, HNO₃) and reducing agent (H₂O₂), the valence state of transition metal is reduced, and the effective leaching of transition metal is realized. There is no doubt about the effectiveness of H₂O₂ as a reducing agent, but H₂O₂ has the disadvantages of poor stability, easy explosion and higher risks. It can be seen that there are various problems in the three processes of recycling of waste lithium-ion batteries. It is urgent to provide a simple and convenient recycling method of waste lithium manganate cathode materials.

### SUMMARY

The present disclosure is aimed at providing a recycling method of waste lithium manganate cathode materials, in order to solve the technical problems of complex process, high energy consumption, waste gas produced and not high leaching rate in the recycling process of waste lithium manganate cathode materials in the existing technology.

In order to achieve the above effects, the present disclosure adopts the following technical solutions:
the present disclosure provides a recycling method of waste lithium manganate cathode materials, including the following steps:
(1) mixing the waste lithium manganate cathode materials with sulfuric acid for a hydrothermal reaction, to obtain manganese dioxide and a washing solution;
(2) reacting the washing solution from step (1) with ammonium bicarbonate, to obtain manganese carbonate and lithium sulfate; and
(3) mixing the manganese dioxide from step (1), lithium sulfate from step (2) and lithium hydroxide monohydrate, then performing a sintering treatment, washing and a tempering treatment in sequence, to obtain recycled lithium manganate cathode materials.

Preferably, a mass-volume ratio of waste lithium manganate cathode materials to sulfuric acid is (2-3) g:(15-25) mL, wherein a concentration of sulfuric acid is 1 mol/L.

Preferably, in step (1), a temperature of the hydrothermal reaction is 100-200° C., and a time of the hydrothermal reaction is 10-30 h.

Preferably, in step (2), a molar ratio of manganese ion to ammonium bicarbonate in the washing solution is 1:(1-2).

Preferably, in step (2), a reaction temperature is 20-30° C. and a reaction time is 5-10 h. Preferably, in step (3), a molar ratio of manganese dioxide, lithium sulfate and lithium hydroxide monohydrate is 2:(0.5-1.5):(1-1.1).

Preferably, in step (3), performing the sintering and tempering treatments in an oxygen atmosphere.

Preferably, in step (3), when performing the sintering treatment, a heating rate is 1-3° C./min, a temperature is 800-900° C., and a holding time is 10-14 h.

Preferably, in step (3), when performing the tempering treatment, firstly, keeping the temperature at 60-100° C. for 4-6 h, then heating the temperature to 700-800° C. for 4-6 h, and a heating rate is 1-3° C./min.

The beneficial effects of the present disclosure are as follows:

(1) The recycling method provided by the present disclosure has a simple process and low cost, which is suitable for industrial production.

(2) The present disclosure can obtain manganese dioxide, spherical manganese carbonate and lithium sulfate by adjusting the reaction temperature and reaction time, realizing the effective recovery of manganese and lithium.

(3) The lithium manganate cathode materials can be re-prepared by using the recovered manganese and lithium and adding lithium hydroxide monohydrate, and the lithium manganate cathode materials have excellent electrochemical performance.

(4) The recycling method of waste lithium manganate cathode materials provided by the present disclosure can realize the recycling of resources and reduce environmental pollution. The recycling method provided by the present disclosure has low requirements for the synthesis equipment, simple operation, no special requirements for the production process, and is environmentally friendly.

### BRIEF DESCRIPTION OF THE DRAWINGS

FIG. 1 shows XRD patterns of manganese dioxide obtained under different hydrothermal reaction conditions in Embodiments 1-4;

FIG. 2 shows SEM images of manganese dioxide obtained under different hydrothermal reaction conditions in Embodiments 1-4;

FIG. 3 shows an SEM image of manganese carbonate prepared in Embodiment 4;

FIG. 4 shows an XRD pattern of the recovered lithium manganate cathode materials in Embodiment 4; and

FIG. 5 shows an electrochemical performance diagram of the recovered lithium manganate cathode materials in Embodiment 4.

### DETAILED DESCRIPTION OF THE EMBODIMENTS

The present disclosure provides a recycling method of waste lithium manganate cathode materials, including the following steps:
(1) mixing the waste lithium manganate cathode materials with sulfuric acid for hydrothermal reaction, to obtain manganese dioxide and a washing solution;
(2) reacting the washing solution from step (1) with ammonium bicarbonate, to obtain manganese carbonate and lithium sulfate; and
(3) mixing the manganese dioxide from step (1), lithium sulfate from step (2) and lithium hydroxide monohydrate, then performing a sintering treatment, washing and a tempering treatment in sequence, to obtain recycled lithium manganate cathode materials.

In the present disclosure, a mass-volume ratio of waste lithium manganate cathode materials to sulfuric acid is (2-3) g:(15-25) m, preferably (2.2-2.8) g:(18-22) mL, further preferably 2.715 g: 20 mL; wherein a concentration of sulfuric acid is 1 mol/L.

In the present disclosure, when the waste lithium manganate cathode materials are mixed with sulfuric acid, it is preferably performed under stirring conditions; wherein a stirring speed is 800-1000 rpm, preferably 850-950 rpm, and further preferably 900 rpm; a stirring time is 0.5-1 h, preferably 0.5 h.

In the present disclosure, in step (1), a hydrothermal reaction temperature is 100-200° C., preferably 120-190° C., and further preferably 160-180° C.; and a hydrothermal reaction time is 10-30 h, preferably 12-28 h, and further preferably 14-24 h.

In the present disclosure, in step (2), a molar ratio of manganese ion to ammonium bicarbonate in the washing solution is 1:(1-2), preferably 1:(1-1.5), and further preferably 1:1.

In the present disclosure, in step (2), a reaction temperature is 20-30° C., preferably 22-28° C., and further preferably 25° C.; and a reaction time is 5-10 h, preferably 6-9 h, and further preferably 7-8 h.

In the present disclosure, in step (3), a molar ratio of manganese dioxide, lithium sulfate and lithium hydroxide monohydrate is 2:(0.5-1.5):(1-1.1), preferably 2:(0.6-1.2):(1.02-1.08), and further preferably 2:(0.8-1.0):(1-1.05).

In the present disclosure, in step (3), performing the sintering and tempering treatments in an oxygen atmosphere.

In the present disclosure, in step (3), when performing the sintering treatment, a heating rate is 1-3° C./min, preferably 2° C./min; a temperature is 800-900° C., preferably 820-880° C., further preferably 850° C.; and a holding time is 10-14 h, preferably 11-13 h, further preferably 12 h.

In the present disclosure, in step (3), when performing the tempering treatment, firstly, keeping the temperature at 60-100° C. for 4-6 hours, preferably at 65-95° C. for 4.5-5.5 h, and further preferably at 70-80° C. for 5 h; then heating the temperature to 700-800° C. for 4-6 hours, preferably to 720-780° C. for 4.5-5.5 h, further preferably to 750° C. for 5 h; and a heating rate is 1-3° C./min, preferably 2° C./min.

In the following, the technical solutions of the present disclosure will be clearly and completely described with the embodiments, however, they can not be understood as limiting the scope of protection of the present disclosure.

### Embodiment 1

2 g of waste lithium manganate cathode materials were mixed with 15 mL of sulfuric acid, where a concentration of sulfuric acid is 1 mol/L, after stirring at 850 rpm for 0.5 h, the mixed products were transferred to a reactor for hydrothermal reaction, a temperature of the hydrothermal reaction is 100° C., and a time of the hydrothermal reaction is 10 h, after the hydrothermal reaction, the black precipitate was washed with deionized water to obtain manganese dioxide and a washing solution, and the manganese dioxide was dried at 80° C. for 24 h. The concentration of Mn ions in the washing solution was measured by ICP, then, according to the molar ratio of manganese ion to ammonium bicarbonate of 1:1, ammonium bicarbonate was added to the washing solution for reaction, a reaction temperature was 25° C. and a reaction time was 5 h, to obtain manganese carbonate and lithium sulfate solution, manganese carbonate was dried at 80° C. for 24 h, and lithium sulfate was obtained by evaporation and crystallization of lithium sulfate solution at 120° C.

Manganese dioxide, lithium sulfate and lithium hydroxide monohydrate were mixed at a molar ratio of 2:0.8:1.05 and performed a sintering treatment in an oxygen atmosphere, where a heating rate is 2° C./min, a sintering temperature is 850° C., and a holding time is 12 h, then the sintered products were washed with warm water and then performed a tempering treatment, where a heating rate of the tempering treatment is 3° C./min, firstly, it was kept at 80° C. for 5 h, then heated to 750° C. for 5 h, and the recycled lithium manganate cathode materials were obtained.

### Embodiment 2

3 g of waste lithium manganate cathode materials were mixed with 25 mL of sulfuric acid, where a concentration of sulfuric acid is 1 mol/L, after stirring at 900 rpm for 1 h, the mixed products were transferred to a reactor for hydrothermal reaction, a temperature of the hydrothermal reaction is 140° C., and a time of the hydrothermal reaction is 16 h, after the hydrothermal reaction, the black precipitate was washed with deionized water to obtain manganese dioxide and a washing solution. The concentration of Mn ions in the washing solution was measured by ICP, then, according to the molar ratio of manganese ion to ammonium bicarbonate of 1:1.05, ammonium bicarbonate was added to the washing solution for reaction, a reaction temperature was 28° C. and a reaction time was 7 h, to obtain manganese carbonate and lithium sulfate solution, manganese carbonate was dried at 80° C. for 24 h, and lithium sulfate was obtained by evaporation and crystallization of lithium sulfate solution at 120° C.

Manganese dioxide, lithium sulfate and lithium hydroxide monohydrate were mixed at a molar ratio of 2:1:1.03 and performed a sintering treatment in an oxygen atmosphere, where a heating rate is 1° C./min, a sintering temperature is 800° C., and a holding time is 14 h, then the sintered products were washed with warm water and then performed a tempering treatment, where a heating rate of the tempering treatment is 2° C./min, firstly, it was kept at 100° C. for 4 h, then heated to 800° C. for 4 h, and the recycled lithium manganate cathode materials were obtained.

### Embodiment 3

2.715 g of waste lithium manganate cathode materials were mixed with 20 mL of sulfuric acid, where a concentration of sulfuric acid is 1 mol/L, after stirring at 880 rpm for 0.5 h, the mixed products were transferred to a reactor for hydrothermal reaction, a temperature of the hydrothermal reaction is 160° C., and a time of the hydrothermal reaction is 20 h, after the hydrothermal reaction, the black precipitate was washed with deionized water to obtain manganese dioxide and a washing solution. The concentration of Mn ions in the washing solution was measured by ICP, then, according to the molar ratio of manganese ion to ammonium bicarbonate of 1:1.07, ammonium bicarbonate was added to the washing solution for reaction, a reaction temperature was 22° C. and a reaction time was 8 h, to obtain manganese carbonate and lithium sulfate solution, manganese carbonate was dried at 80° C. for 24 h, and lithium sulfate was obtained by evaporation and crystallization of lithium sulfate solution at 120° C.

Manganese dioxide, lithium sulfate and lithium hydroxide monohydrate were mixed at a molar ratio of 2:0.5:1.08 and performed a sintering treatment in an oxygen atmosphere, where a heating rate is 3° C./min, a sintering temperature is 900° C., and a holding time is 10 h, then the sintered products were washed with warm water and then performed a tempering treatment, where a heating rate of the tempering treatment is 1° C./min, firstly, it was kept at 60° C. for 6 h, then heated to 700° C. for 6 h, and the recycled lithium manganate cathode materials were obtained.

### Embodiment 4

2.715 g of waste lithium manganate cathode materials were mixed with 20 mL of sulfuric acid, where a concentration of sulfuric acid is 1 mol/L, after stirring at 1000 rpm for 0.5 h, the mixed products were transferred to a reactor for hydrothermal reaction, a temperature of the hydrothermal reaction is 200° C., and a time of the hydrothermal reaction is 24 h, after the hydrothermal reaction, the black precipitate was washed with deionized water to obtain manganese dioxide and a washing solution. The concentration of Mn ions in the washing solution was measured by ICP, then, according to the molar ratio of manganese ion to ammonium bicarbonate of 1:1, ammonium bicarbonate was added to the washing solution for reaction, a reaction temperature was 25° C. and a reaction time was 10 h, to obtain manganese carbonate and lithium sulfate solution, manganese carbonate was dried at 80° C. for 24 h, and lithium sulfate was obtained by evaporation and crystallization of lithium sulfate solution at 120° C.

Manganese dioxide, lithium sulfate and lithium hydroxide monohydrate were mixed at a molar ratio of 2:0.8:1.05 and performed a sintering treatment in an oxygen atmosphere, where a heating rate is 2° C./min, a sintering temperature is 850° C., and a holding time is 12 h, then the sintered products were washed with warm water and then performed a tempering treatment, where a heating rate of the tempering treatment is 3° C./min, firstly, it was kept at 80° C. for 5 h, then heated to 750° C. for 5 h, and the recycled lithium manganate cathode materials were obtained.

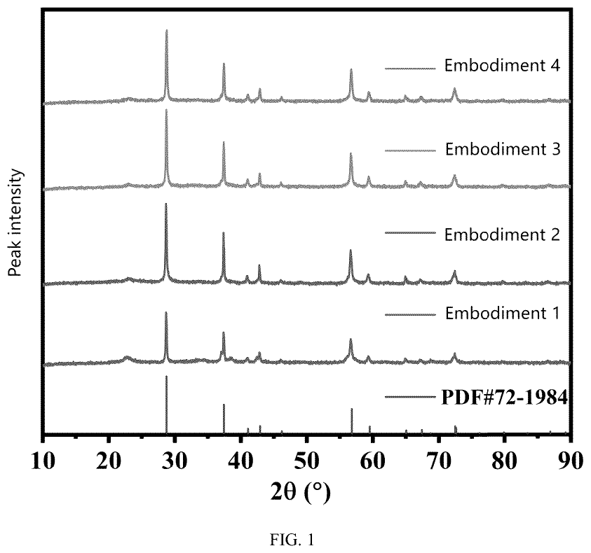

FIG. 1 shows XRD patterns of manganese dioxide obtained under different hydrothermal reaction conditions in Embodiments 1-4. It can be seen from FIG. 1, that the obtained manganese dioxide has no secondary phase and impurity peak, all diffraction peaks point to the manganese dioxide standard card (PDF #72-1984), and they are standard manganese dioxide materials.

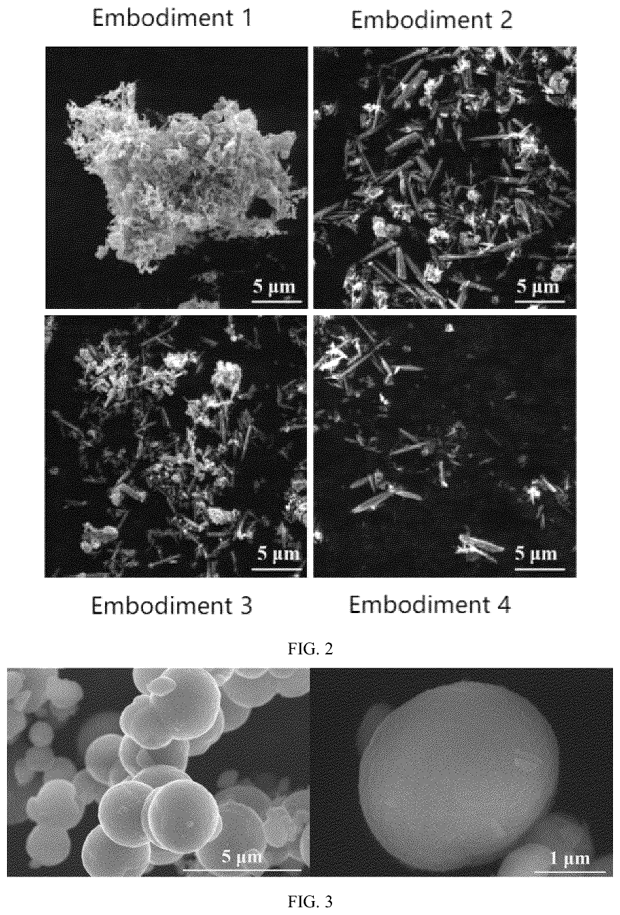

FIG. 2 shows SEM images of manganese dioxide obtained under different hydrothermal reaction conditions in Embodiments 1-4. It can be seen from FIG. 2, that with the increase of hydrothermal reaction temperature and the extension of hydrothermal reaction time, the aggregation phenomenon of manganese dioxide gradually decreases, showing a rod-like structure.

FIG. 3 shows an SEM image of manganese carbonate prepared in Embodiment 4. It can be seen from FIG. 3 that the obtained manganese carbonate is spherical.

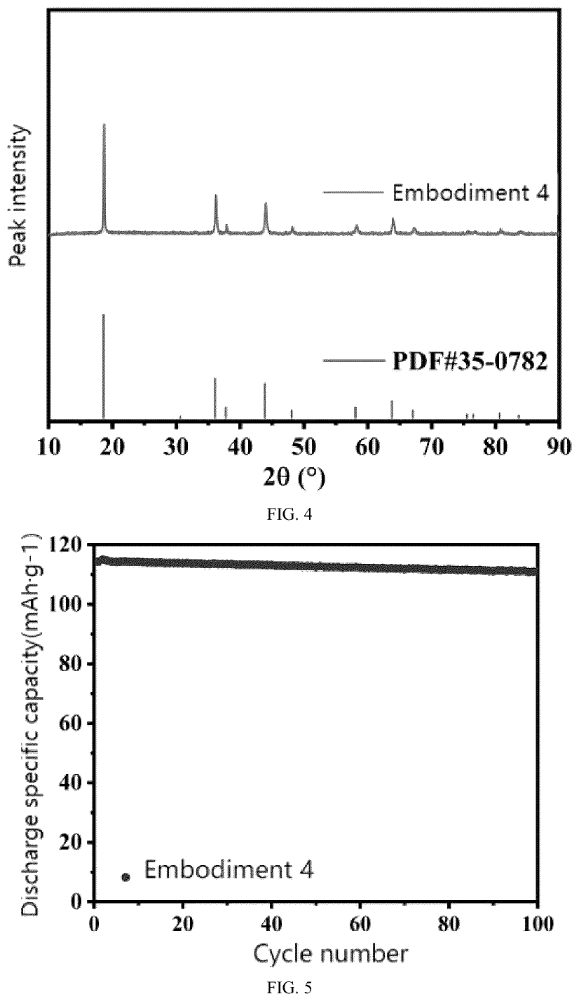

FIG. 4 shows an XRD pattern of the recovered lithium manganate cathode materials in Embodiment 4. It can be seen from FIG. 4, that the recycled lithium manganate cathode materials have no secondary phase and impurity peak, all diffraction peaks point to the spinel LiMn2O4 standard card (PDF #35-0782), all belong to Fd-3m space group, and they are standard lithium manganate cathode materials.

FIG. 5 shows an electrochemical performance diagram of the recovered lithium manganate cathode materials in Embodiment 4. It can be seen from FIG. 5 that the lithium manganate cathode materials prepared by the molten salt method have a higher initial discharge specific capacity of 114.3 mAh·g⁻¹ and a cycle retention rate of 97.1%.

It can be seen from the above embodiments, that the present disclosure provides a recycling method of waste lithium manganate cathode materials. In the present disclosure firstly, mixing the waste lithium manganate cathode materials with sulfuric acid for hydrothermal reaction, to obtain manganese dioxide and washing solution; then reacting the washing solution with ammonium bicarbonate, to obtain manganese carbonate and lithium sulfate; and mixing the manganese dioxide, lithium sulfate and lithium hydroxide monohydrate, then performing a sintering treatment, washing and a tempering treatment in sequence, to obtain recycled lithium manganate cathode materials. The present disclosure can obtain manganese dioxide, spherical manganese carbonate and lithium sulfate by adjusting the reaction temperature and reaction time, realizing the effective recovery of manganese and lithium. The lithium manganate cathode materials can be re-prepared by using the recovered manganese and lithium and adding lithium hydroxide monohydrate, and the lithium manganate cathode materials have excellent electrochemical performance.

The above is only the preferred embodiment of the present disclosure. It should be pointed out that for those of ordinary skill in the art, on the premise of not deviating from the principle of the present disclosure, some improvements and embellishments can also be made. These improvements and embellishments should also be regarded as the scope of protection of the present disclosure.

What is claimed is:

1. A recycling method of waste lithium manganate cathode materials, comprising the following steps:
(1) mixing the waste lithium manganate cathode materials with sulfuric acid for a hydrothermal reaction, to obtain manganese dioxide and a washing solution;
(2) reacting the washing solution from the step (1) with ammonium bicarbonate, to obtain manganese carbonate and lithium sulfate; and
(3) mixing the manganese dioxide from the step (1), the lithium sulfate from the step (2), and lithium hydroxide monohydrate to obtain a mixture, then performing a sintering treatment, a washing treatment, and a tempering treatment on the mixture in sequence, to obtain recycled lithium manganate cathode materials.

2. The recycling method according to claim 1, wherein a mass-volume ratio of the waste lithium manganate cathode materials to the sulfuric acid is (2-3) g:(15-25) mL, wherein a concentration of the sulfuric acid is 1 mol/L.

3. The recycling method according to claim 1, wherein in the step (1), a temperature of the hydrothermal reaction is 100-200° C., and a time of the hydrothermal reaction is 10-30 h.

4. The recycling method according to claim 3, wherein in the step (2), a molar ratio of manganese ion to the ammonium bicarbonate in the washing solution is 1:(1-2).

5. The recycling method according to claim 2, wherein in the step (2), a reaction temperature is 20-30° C. and a reaction time is 5-10 h.

6. The recycling method according to claim 5, wherein in the step (3), a molar ratio of the manganese dioxide, the lithium sulfate, and the lithium hydroxide monohydrate is 2:(0.5-1.5):(1-1.1).

7. The recycling method according to claim 1, wherein in the step (3), the sintering treatment and the tempering treatment are performed in an oxygen atmosphere.

8. The recycling method according to claim 7, wherein in the step (3), when performing the sintering treatment, a heating rate is 1-3° C./min, a temperature is 800-900° C., and a holding time is 10-14 h.

9. The recycling method according to claim 6, wherein in the step (3), when performing the tempering treatment, firstly, keeping a temperature at 60-100° C. for 4-6 h, then heating the temperature to 700-800° C. for 4-6 h, and a heating rate is 1-3° C./min.

10. The recycling method according to claim 2, wherein in the step (1), a temperature of the hydrothermal reaction is 100-200° C., and a time of the hydrothermal reaction is 10-30 h.

11. The recycling method according to claim 10, wherein in the step (2), a molar ratio of manganese ion to the ammonium bicarbonate in the washing solution is 1:(1-2).

12. The recycling method according to claim 4, wherein in the step (2), a reaction temperature is 20-30° C. and a reaction time is 5-10 h.

13. The recycling method according to claim 12, wherein in the step (3), a molar ratio of the manganese dioxide, the lithium sulfate, and the lithium hydroxide monohydrate is 2:(0.5-1.5):(1-1.1).

14. The recycling method according to claim 4, wherein in the step (3), the sintering treatment and the tempering treatment are performed in an oxygen atmosphere.

15. The recycling method according to claim 6, wherein in the step (3), the sintering treatment and the tempering treatment are performed in an oxygen atmosphere.

16. The recycling method according to claim 14, wherein in the step (3), when performing the sintering treatment, a heating rate is 1-3° C./min, a temperature is 800-900° C., and a holding time is 10-14 h.

17. The recycling method according to claim 15, wherein in the step (3), when performing the sintering treatment, a heating rate is 1-3° C./min, a temperature is 800-900° C., and a holding time is 10-14 h.

18. The recycling method according to claim 8, wherein in the step (3), when performing the tempering treatment, firstly, keeping a temperature at 60-100° C. for 4-6 h, then heating the temperature to 700-800° C. for 4-6 h, and a heating rate is 1-3° C./min.

19. The recycling method according to claim 11, wherein in the step (2), a reaction temperature is 20-30° C. and a reaction time is 5-10 h.

20. The recycling method according to claim 19, wherein in the step (3), a molar ratio of the manganese dioxide, the lithium sulfate, and the lithium hydroxide monohydrate is 2:(0.5-1.5):(1-1.1).
